(19) United States
(12) Patent Application Publication
(10) Pub. No.: US 2012/0054371 A1
(43) Pub. Date: Mar. 1, 2012

(54) EMITTER APPARATUS, 3D IMAGE DISPLAY APPARATUS, AND COMMAND SENDING METHOD

(75) Inventors: Masahiro Yamada, Kanagawa (JP); Ichiro Sato, Tokyo (JP)

(73) Assignee: Sony Corporation, Tokyo (JP)

(21) Appl. No.: 13/207,702

(22) Filed: Aug. 11, 2011

(30) Foreign Application Priority Data
Aug. 24, 2010 (JP) P2010-186985

(51) Int. Cl. G06F 3/00

(52) U.S. Cl. 710/5

(57) ABSTRACT

An emitter apparatus includes a plurality of generating sections and a command sending section. The plurality of generating sections are capable of generating command signals of a plurality of protocols, respectively, the plurality of protocols corresponding to a plurality of pairs of active shutter glasses having different protocols for controlling right-and-left shutters, respectively. The command sending section is configured to time-division multiplex the command signals of the plurality of protocols generated in the plurality of generating sections, and to send the command signals.

### BACKGROUND

The present disclosure relates to an emitter apparatus supplying command signals for controlling opening/closing right-and-left shutters to active shutter glasses, a 3D (three-dimensional) image display apparatus, and a command sending method.

An image display apparatus designed for 3D images of twin-eye stereo images displays a right-eye image and a left-eye image simultaneously or time-divisionally, and opens right-and-left shutters of active shutter glasses that a viewer wears on his both eyes in shifted times such that the right-eye image is shown to the right eye of the viewer and the left-eye image is shown to the left eye of the viewer, separately. An emitter apparatus is used as a device sending command signals for controlling the active shutter glasses as described above. The emitter apparatus generates a series of command signals for controlling opening/closing shutters based on a synchronization signal supplied from the image display apparatus, and sends the command signals as radiated signals of an infrared light or an electromagnetic wave. Meanwhile, the active shutter glasses receive the above-mentioned command signals from the emitter apparatus, and drive the right-and-left shutters structured by, for example, liquid-crystal plates to open/close based on the command signals. Each of the right-and-left shutters opens at least once in one cycle of switching images such as a frame in a time-shifted manner, whereby a viewer recognizes a 3D image because of parallax of images entering the right and left eyes every time each of the right-and-left shutters opens. For example, Japanese Patent Application Laid-open No. H8-327961 (Hereinafter referred to as Patent Document 1) and the like disclose 3D display viewing systems of twin-eye stereo images using the above-mentioned active shutter glasses.

Further, Japanese Patent Application Laid-open No. H7-222087 (Hereinafter referred to as Patent Document 2) discloses a system in which a plurality of images (channels) whose image sources themselves are different from each other are time-divisionally displayed on one screen, not displaying right-and-left images time-divisionally. Synchronization signals for respective channels are sent to respective plurality of pairs of active shutter glasses prepared for respective channels. Therefore, active shutter glasses corresponding to channels that a plurality of viewers wish to view through one screen are selected and used, whereby a plurality of viewers may view a plurality of different images through one screen simultaneously.

In general, command signals for shutter open/close controls sent from an emitter apparatus to active shutter glasses include four kinds of signal patterns of a left-eye shutter open signal, a left-eye shutter close signal, a right-eye shutter open signal, and a right-eye shutter close signal. Protocols of those command signals, for example, structures of command signals such as bit pattern or the number of bits are not standardized. Protocols may be different from each other depending on manufacturers or different from each other depending on product types of the same manufacturer. Further, sub-carrier frequencies and wavelengths of light sources in a case of sending command signals using infrared light signals are not standardized either. As a result, active shutter glasses are exclusively provided with a 3D image display apparatus main body in set form, and the active shutter glasses may only be used as exclusive glasses for the 3D image display apparatus.

### SUMMARY

In view of the above-mentioned circumstances, it is desirable to provide an emitter apparatus capable of controlling a plurality of pairs of active shutter glasses having different protocols for controlling right-and-left shutters, a 3D image display apparatus, and a command sending method.

According to an embodiment of the present disclosure, there is provided an emitter apparatus, including a plurality of generating sections capable of generating command signals of a plurality of protocols, respectively, the plurality of protocols corresponding to a plurality of pairs of active shutter glasses having different protocols for controlling right-and-left shutters, respectively, and a command sending section configured to time-division multiplex the command signals of the plurality of protocols generated in the plurality of generating sections, and to send the command signals.

According to the embodiment of the present disclosure, the command sending section time-division multiplexes command signals of a plurality of protocols for controlling a plurality of pairs of active shutter glasses, respectively, and sends the command signals. Therefore, one emitter apparatus may control a plurality of pairs of active shutter glasses. As a result, a plurality of users may view a 3D image displayed on a 3D image display apparatus to which the emitter apparatus according to the embodiment of the present disclosure is connected by using a plurality of pairs of active shutter glasses having different protocols.

The plurality of pairs of active shutter glasses may be capable of continuing operations of alternately opening and closing the right-and-left shutters for predetermined self-propellable times after the command signals stop, respectively. The command sending section may be configured to time-division multiplex the command signals of the respective protocols such that an intermittent time of each of the command signals of the protocols fails to exceed the self-propellable time, and to send the command signals.

Therefore, when time-division multiplexed command signals of respective protocols control a plurality of pairs of active shutter glasses, each pair of active shutter glasses in a self-propellable state surely continue a shutter open/close operation. That may increase reliability.

The command sending section may be configured to time-division multiplex the command signals of the respective protocols in time units corresponding to a predetermined number of frames, respectively, and to send the command signals.

Therefore, command signals that complete in a frame are obtained for each protocol. In other words, a command-signal protocol is not changed at a midpoint in a frame.

Therefore, shutter open/close controls by command signals for each protocol may be performed stably.

The predetermined number of frames is the minimum number of frames that each pair of the active shutter glasses are capable of calculating an open/close cycle of the right-and-left shutters.

Therefore, each active shutter glasses surely calculate an open/close cycle of right-and-left shutters necessary for continuing an operation to alternately open/close the right-and-left shutters during a self-propellable time after command signals stop.

The command sending section may be configured to switch the command signals of the respective protocols such that the respective command signals sandwich at least one blank frame, and to send the command signals.

Further, at least one protocol may define that a chain of signals including a no-signal segment of a first predetermined number of frames and signal segments of a second predetermined number of frames before and after the no-signal segment are used as a trigger for starting a control by the corresponding active shutter glasses. The command sending section may be configured to send, in at least part of a period corresponding to the no-signal segment, a command signal corresponding to at least one other protocol.

The command sending section may include a plurality of infrared light sources capable of emitting infrared light signals having wavelengths corresponding to the plurality of protocols, respectively.

Therefore, in a case where wavelengths of infrared light signals that a plurality of pairs of active shutter glasses may receive are different from each other, infrared-light command signals for shutter open/close controls may be transmitted to active shutter glasses.

According to another embodiment of the present disclosure, there is provided a 3D image display apparatus, including the above-mentioned emitter apparatus.

Therefore, a plurality of users may view a 3D image displayed on the 3D image display apparatus according to the embodiment of the present disclosure by using a plurality of pairs of active shutter glasses having different protocols.

According to another embodiment of the present disclosure, there is provided a command sending method by an emitter apparatus, including generating command signals of a plurality of protocols, respectively, the plurality of protocols corresponding to a plurality of pairs of active shutter glasses having different protocols for controlling right-and-left shutters, respectively, and time-division multiplexing the respective generated command signals of the plurality of protocols, and sending the command signals.

As described above, according to the embodiments of the present disclosure, a plurality of pairs of active shutter glasses having different protocols for controlling right-and-left shutters may be controlled. Further, a plurality of users may view a 3D image displayed on a 3D image display apparatus by using a plurality of pairs of active shutter glasses having different protocols.

These and other objects, features and advantages of the present disclosure will become more apparent in light of the following detailed description of best mode embodiments thereof, as illustrated in the accompanying drawings.

### BRIEF DESCRIPTION OF DRAWINGS

FIG. 1 is a conceptual diagram showing the structure of a 3D image viewing system according to a first embodiment of the present disclosure;

FIG. 2 is a timing diagram relating to typical shutter open/close controls based on command signals from an emitter apparatus;

FIG. 3 is a diagram showing waveforms of four kinds of command signals of a first protocol;

FIG. 4 is a diagram showing waveforms of four kinds of command signals of a second protocol;

FIG. 5 is a block diagram showing the structure of a 3D image display apparatus having the internal emitter apparatus according to the first embodiment;

FIG. 6 is a block diagram showing a detailed structure of the emitter apparatus of FIG. 5;

FIG. 7 is a block diagram showing the structure of glasses;

FIG. 8 is a timing diagram relating to shutter open/close controls of two pairs of glasses of the first embodiment;

FIG. 9 is a simplified diagram of the timing diagram of FIG. 8;

FIG. 10 is a timing diagram relating to shutter open/close controls of the two pairs of glasses according to a second embodiment;

FIG. 11 is a diagram explaining a protocol that a chain of command signals including a no-signal segment and signal segments before and after the no-signal segment are defined as a trigger for starting a shutter open/close control;

FIG. 12 is a timing diagram relating to shutter open/close controls of the two pairs of glasses according to a third embodiment;

FIG. 13 is a simplified diagram of the timing diagram of FIG. 12;

FIG. 14 is a timing diagram relating to shutter open/close controls of the two pairs of glasses according to a fourth embodiment;

FIG. 15 is a block diagram showing the structure of an emitter apparatus according to a modified example 1 of the embodiments;

FIG. 16 is a block diagram showing the structure of an emitter apparatus according to a modified example 2 of the embodiments;

FIG. 17 is a block diagram showing the structure of an emitter apparatus according to a modified example 3 of the embodiments; and

FIG. 18 is a conceptual diagram showing an emitter apparatus according to a modified example 4 of the embodiments.

### DETAILED DESCRIPTION OF EMBODIMENTS

Hereinafter, embodiments of the present disclosure will be described with reference to the drawings.

### First Embodiment

### Structure of 3D Image Viewing System

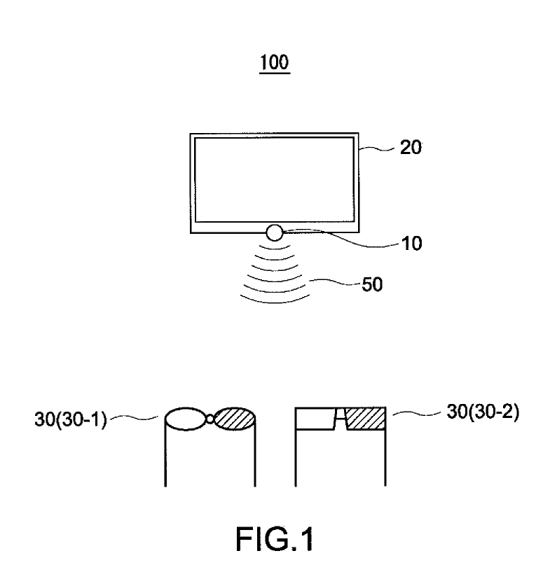

FIG. 1 is a conceptual diagram showing the structure of a 3D image viewing system according to a first embodiment of the present disclosure.

A 3D image viewing system 100 includes a 3D image display apparatus 20 having an internal emitter apparatus 10, and a plurality of pairs of active shutter glasses 30 (hereinafter simply referred to as “glasses”.). Note that, in this embodiment, to make the description simple, a case where two pairs of glasses are used will be described.

The 3D image display apparatus 20 having the internal emitter apparatus 10 is, for example, a display apparatus capable of showing 3D images of twin-eye stereo images or the like, and its product form is, specifically, a television apparatus or the like, for example.

Each of the two pairs of glasses 30 are active shutter glasses that a user wears on his both eyes, who is a viewer of 3D images displayed by the 3D image display apparatus 20. The specs of the two pairs of glasses 30 are different from each other in communication protocol (hereinafter referred to as “protocol”.) including bit pattern, number of bits, sub-carrier frequency, and the like of command signals for controlling opening/closing shutters.

Hereinafter, in a case where the two pairs of glasses 30 are distinguished from each other, one pair of glasses are referred to as “first glasses 30-1”, and the other pair of glasses are referred to as “second glasses 30-2”. Further, the protocol employed for the first glasses 30-1 is referred to as “first protocol”, and the protocol employed for the second glasses 30-2 is referred to as “second protocol”.

The emitter apparatus 10 embedded in the 3D image display apparatus 20 is structured so as to be capable of emitting (sending) infrared-light command signals 50 corresponding to the protocols of the plurality of pairs of glasses 30, respectively, to the plurality of pairs of glasses 30 having protocols different from each other by shifting time utilizing self-propellable periods of the plurality of pairs of glasses 30, respectively.

### (Typical Shutter Open/Close Control)

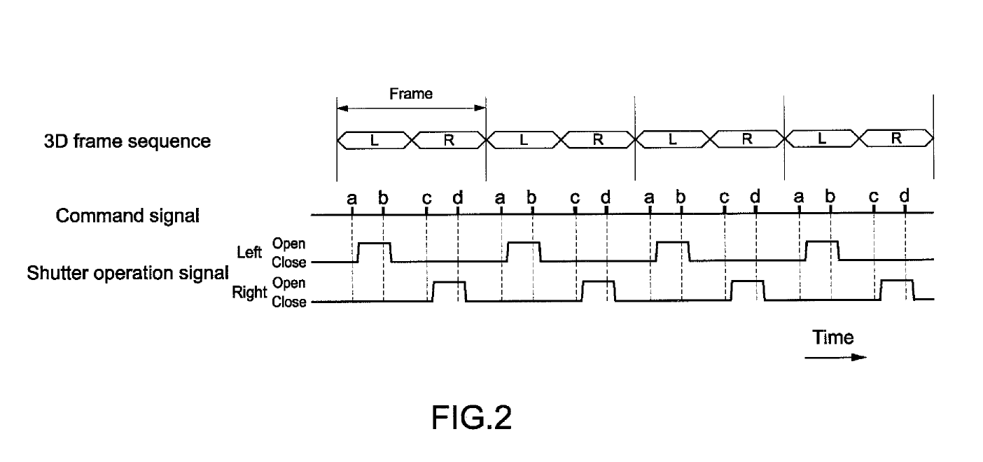

FIG. 2 is a timing diagram relating to shutter open/close controls of the glasses 30 based on the command signals from the emitter apparatus 10. Note that, in the example of FIG. 2, it is assumed that the field sequential system for switching left-eye images and right-eye images on a field basis is employed. Based on a series of infrared-light command signals received from the emitter apparatus 10, the glasses 30 open and close a left-eye shutter once in an odd field period in which a left-eye image is displayed, and open and close a right-eye shutter once in an even field period in which a right-eye image is displayed. Therefore, a viewer recognizes 3D images because of parallax of images entering the right and left eyes.

The command signals sent from the emitter apparatus 10 includes the following four kinds.

L-open (open left shutter)

L-close (close left shutter)

R-open (open right shutter)

R-close (close right shutter)

That is, the emitter apparatus 10 sequentially sends the L-open command and the L-close command in the odd field period in which a left-eye image is displayed, and sequentially sends the R-open command and the R-close command in the even field period in which a right-eye image is displayed.

### (Protocols of Command Signals)

Protocols of the command signals for controlling open/close of the shutters of the glasses 30 may be different from each other depending on manufacturers or different from each other depending on product types of the same manufacturer.

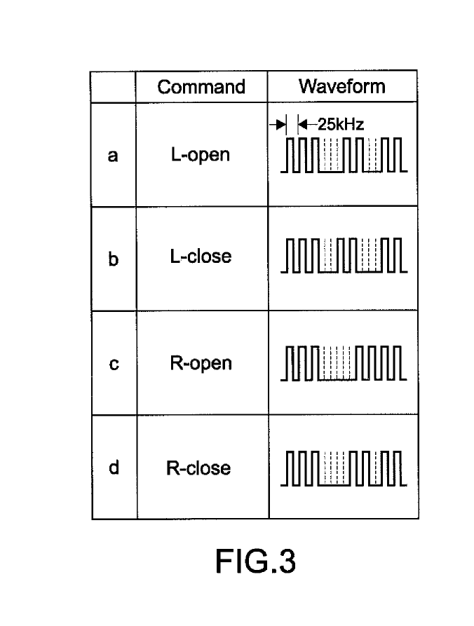

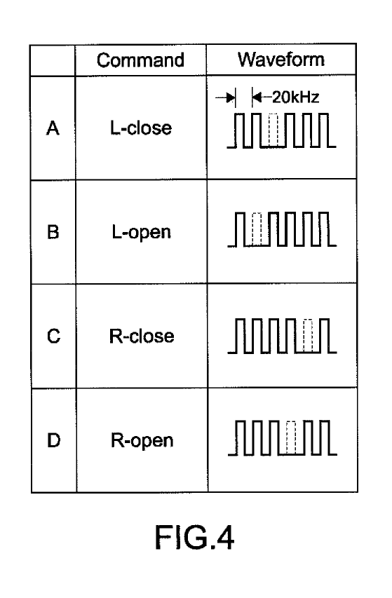

FIG. 3 is a diagram showing waveforms of four kinds of command signals a, b, c, d of the first protocol used for the first glasses 30-1. FIG. 4 is a diagram showing waveforms of four kinds of command signals A, B, C, D of the second protocol used for the second glasses 30-2. Comparison of those diagrams indicates that the bit patterns, the numbers of bits, the sub-carrier frequencies, and the like, which are elements characterizing command signal waveforms, are different between the two protocols.

Note that the waveforms of the command signals shown in FIGS. 3 and 4 are modulated signals suitable for transmission/reception of infrared light signals. For example, the values of the respective bits of the command signals correspond to on/off of driving of an infrared light source as they are.

Note that the above description is also common to the other embodiments described below.

(Structure of 3D Image Display Apparatus Having Internal Emitter Apparatus)

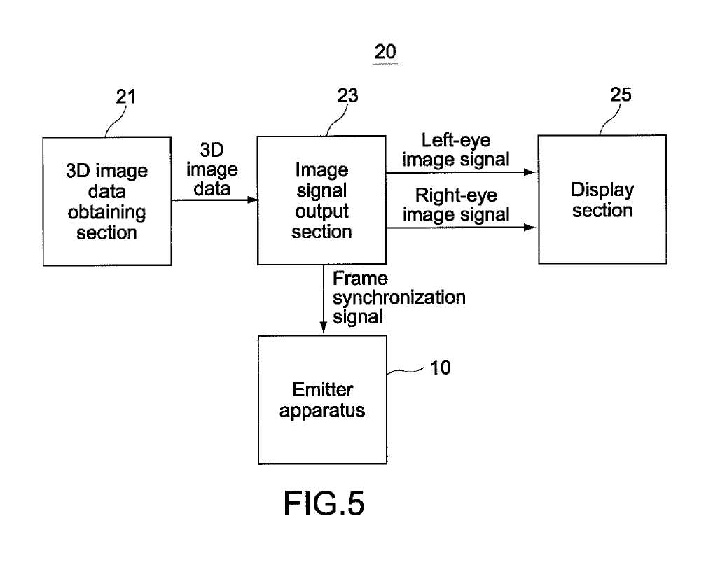

FIG. 5 is a block diagram showing the structure of the 3D image display apparatus 20 having the internal emitter apparatus 10. The 3D image display apparatus 20 includes, in addition to the emitter apparatus 10, a 3D image data obtaining section 21, an image signal output section 23, and a display section 25.

The 3D image data obtaining section 21 obtains time-division 3D image data from, for example, media such as Blu-ray Discs, broadcast, the Internet, other apparatuses that treat 3D image data, and the like, and supplies the 3D image data to the image signal output section 23.

The image signal output section 23, for example, decodes the supplied 3D image data to thereby generate the respective left-eye image and right-eye image, and outputs them to the display section 25. With the output of the left-eye image and the right-eye image to the display section 25, the image signal output section 23 supplies a synchronization signal in sync with the switch of images of frames and the like to the emitter apparatus 10.

In this embodiment, the system in which complementary fields are assigned to left-eye images and right-eye images, respectively, and the images are output is employed. Alternatively, a method including simultaneously outputting left-eye image signals and right-eye image signals, or a method including assigning left-eye image signals and right-eye image signals in frame and outputting the images may be employed.

The display section 25 displays right-and-left parallax images on a screen. As the display section 25, for example, a liquid crystal display apparatus, a plasma display apparatus, an organic EL (Electro Luminescence) display apparatus, or the like is used.

### (Structure of Emitter Apparatus)

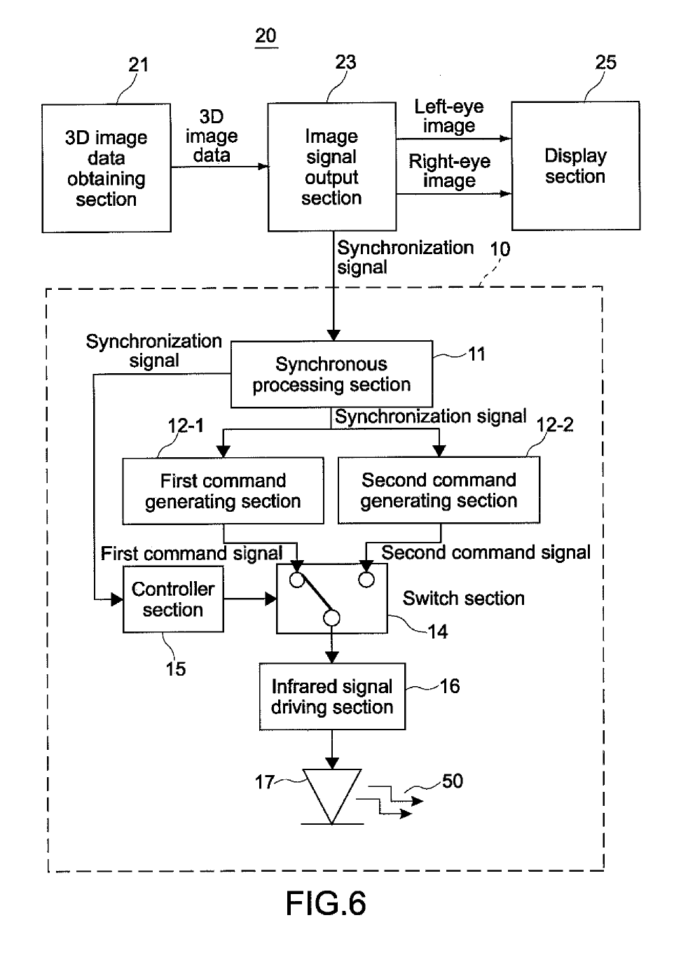

FIG. 6 is a block diagram showing a detailed structure of the emitter apparatus 10 of FIG. 5. The emitter apparatus 10 includes a synchronous processing section 11, a first command generating section 12-1, a second command generating section 12-2, a switch section 14, a controller section 15, an infrared signal driving section 16, and an infrared light source 17. Here, the first command generating section 12-1 and the second command generating section 12-2 correspond to “plurality of generating sections” in claims. The switch section 14, the controller section 15, the infrared signal driving section 16, and the infrared light source 17 correspond to “command sending section” in claims.

The synchronous processing section 11 supplies the synchronization signal supplied from the image signal output section 23 to the first command generating section 12-1, the second command generating section 12-2, and the controller section 15.

The first command generating section 12-1 generates a series of first command signals corresponding to the first protocol for controlling open/close of the shutters of the first glasses 30-1.

The second command generating section 12-2 generates a series of second command signals corresponding to the second protocol for controlling open/close of the shutters of the second glasses 30-2.

In response to the synchronization signals from the synchronous processing section 11, the first command generating section 12-1 and the second command generating section 12-2 generate the series of first command signals corresponding to the first protocol and the series of second command signals corresponding to the second protocol, respectively, and supply the command signals to the switch section 14.

Based on a switching signal from the controller section 15, the switch section 14 selects, from the series of first command signals and the series of second command signals supplied from the first command generating section 12-1 and the second command generating section 12-2, one series of command signals, and supplies the command signals to the infrared signal driving section 16.

The controller section 15 controls the switch section 14 to time-division multiplex the command signals of the plurality of protocols. That is, based on the synchronization signal from the synchronous processing section 11, the controller section 15 controls the switch section 14 to switch the series of first command signals and the series of second command signals to select one of them every N frames. Here, N is the minimum number of frames necessary for calculating a shutter open/close cycle of each pair of glasses 30. For example, N=2.

The infrared signal driving section 16 drives the infrared light source 17 such that the infrared light source emits the infrared-light command signals 50 corresponding to the waveform of the command signals supplied from the switch section 14.

The infrared light source 17 is a light source such as a light-emitting diode, for example, that emits the infrared-light command signals 50.

### (Structure of Glasses)

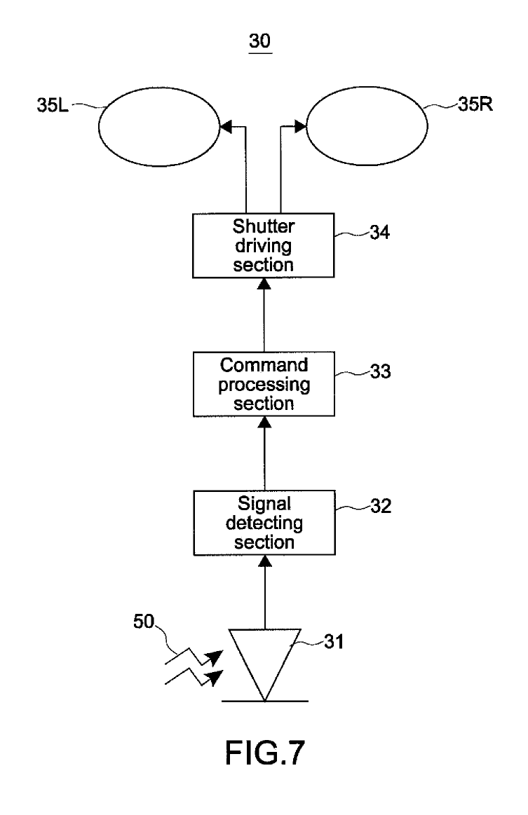

FIG. 7 is a block diagram showing the structure of the glasses 30.

The basic structure of the first glasses 30-1 is the same as the basic structure of the second glasses 30-2.

As shown in FIG. 7, the glasses 30 include a infrared light receiving section 31, a signal detecting section 32, a command processing section 33, a shutter driving section 34, right-and-left shutters 35R, 35L, and the like.

The infrared light receiving section 31 receives the infrared-light command signals 50 sent from the emitter apparatus 10 through a wavelength filter (not shown), converts them to electric signals, and supplies them to the signal detecting section 32.

The signal detecting section 32 selectively extracts signals of the receiving-target sub-carrier frequency from the electric signals supplied from the infrared light receiving section 31 through a bandpass filter (not shown), binarizes them, and supplies waveform patterns obtained as the result to the command processing section 33.

The command processing section 33 includes a memory (not shown) storing information on reference waveform patterns corresponding to the above-mentioned four kinds of commands.

The command processing section 33 performs matching of reference waveform patterns of the respective commands stored in the memory and the waveform pattern supplied from the signal detecting section 32 to thereby determine a command, and controls the shutter driving section 34 based on the command.

Controlled by the command processing section 33, the shutter driving section 34 drives the right-and-left shutters 35R, 35L.

Each of the right-and-left shutters 35R, 35L is structured by, for example, a liquid crystal device or the like. The right-and-left shutters 35R, 35L are separately operated to open/close by the shutter driving section 34.

The basic structure of the first glasses 30-1 is similar to the basic structure of the second glasses 30-2. Depending on protocols of the command signals, for example, transmission wavelength bands of the wavelength filter of the infrared light receiving section 31, a transmission frequency range of the bandpass filter of the signal detecting section 32, reference waveform patterns of the command of the command processing section 33, and the like are determined.

Further, the glasses 30 are structured so as to be capable of continuing, after a command signal from the emitter apparatus 10 stops, an open/close operation at a shutter open/close cycle, which has been calculated, for a predetermined time period without depending on the command signal. Here, a time period that the glasses 30 are capable of continuing a shutter open/close operation without depending on a command signal is referred to as “self-propellable time”. The self-propellable time varies among the kinds of glasses, and is, for example, about three seconds or four seconds. Receiving a next command signal during a self-propellable time, the command processing section 33 shifts from a self-propellable state (state where the command processing section 33 executes the shutter open/close operation without depending on a command signal) to a control state in response to the command. Further, in a case where the command processing section 33 fails to receive a next command signal during a self-propellable time, as a reset operation, both the right-and-left shutters 35R, 35L are fixed to open states until the command processing section 33 receives a next command signal. Since such a self-propellable time is provided, in a case where the glasses 30 temporarily fail to receive an infrared-light command signal because an object such as a person passes between the emitter apparatus 10 and the glasses 30, for example, the shutter open/close control is not interrupted, whereby it is possible to stably show 3D images a viewer.

The emitter apparatus 10 of this embodiment time-division multiplexes command signals of the respective protocols such that intermittent times of the command signals of the respective protocols do not exceed self-propellable times, respectively, and sends the command signals. That is, the emitter apparatus 10 of this embodiment alternately switches the continuous N frames of series of first command signals and the continuous N frames of series of second command signals, and sends the command signals. Here, N is the minimum number of frames necessary for calculating a shutter open/close cycle of each pair of glasses 30. For example, N=2.

Therefore, the one emitter apparatus 10 may perform the shutter open/close controls of the two pairs of glasses 30-1, 30-2 having different protocols.

Further, in a case where there are three or more pairs of glasses having different protocols, the emitter apparatus 10 may time-division multiplex command signals of the respective protocols such that intermittent times of the command signals of the respective protocols do not exceed self-propellable times, respectively, and send the command signals.

### (Shutter Open/Close Control Operations of Two Pairs of Glasses)

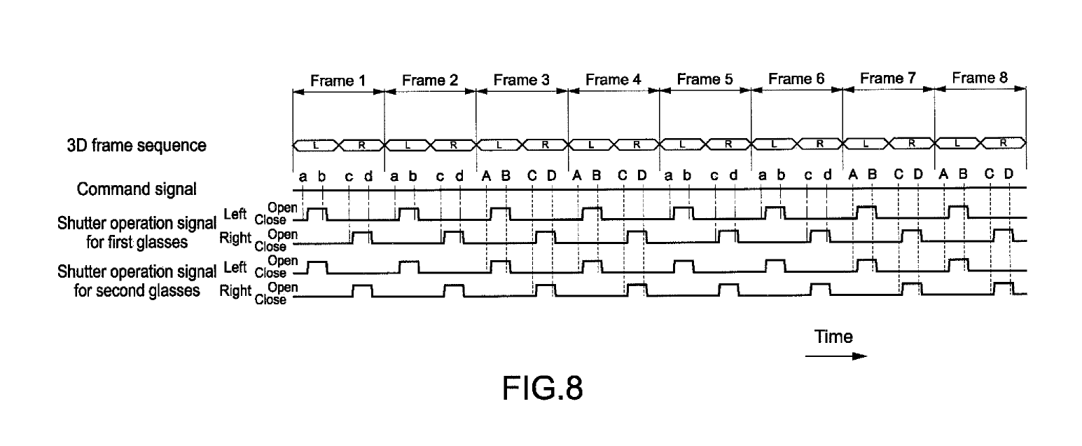

FIG. 8 is a timing diagram relating to shutter open/close controls of the two pairs of glasses 30-1, 30-2 of this embodiment. Beginning at the top, timings of a 3D image frame sequence, infrared-light command signals, left-eye shutter operation signals of the first glasses 30-1, right-eye shutter operation signals of the first glasses 30-1, left-eye shutter operation signals of the second glasses 30-2, and right-eye shutter operation signals of the second glasses 30-2 are shown. Further, a, b, c, and d show sending timings of the series of first command signals L-open, L-close, R-open, and R-close corresponding to the first protocol, respectively. A, B, C, and D show sending timings of the series of second command signals corresponding to the second protocol, respectively.

First, in the emitter apparatus 10, the synchronous processing section 11 supplies a synchronization signal supplied from the image signal output section 23 to each of the first command generating section 12-1, the second command generating section, 12-2 and the controller section 15.

In response to the synchronization signal from the synchronous processing section 11, the first command generating section 12-1 generates a series of first command signals corresponding to the first protocol, and supplies the command signals to the switch section 14. At the same time, in response to the synchronization signal from the synchronous processing section 11, the second command generating section 12-2 generates a series of second command signals corresponding to the second protocol, and supplies the command signals to the switch section 14.

Note that FIG. 8 shows a case where the command signals of each protocol are generated in the order of L-open, L-close, R-open, and R-close. Alternatively, the command signals may be generated in the order of R-open, R-close, L-open, and L-close.

Meanwhile, in order to time-division multiplex the command signals of the plurality of protocols, the controller section 15 supplies the switching signal to the switch section every time the controller section 15 receives N (for example, N=2) times of the synchronization signals from the synchronous processing section 11. Therefore, the switch section 14 alternately selects the series of first command signals corresponding to the first protocol and the series of second command signals corresponding to the second protocol every N frames, and supplies the selected series of command signals to the infrared signal driving section 16 every time a series of command signals are selected.

Receiving the command signals from the switch section 14, the infrared signal driving section 16 drives the infrared light source 17 such that the infrared light source 17 emits infrared light signals corresponding to the waveform of the command signals. As a result, the infrared light source 17 alternately switches the continuous N frames of series of infrared-light first command signals 50 corresponding to the first protocol and the continuous N frames of series of infrared-light second command signals 50 corresponding to the second protocol, and sends the command signals.

This operation will be described with reference to FIG. 8. In a period of time during the frames 1 and 2, the emitter apparatus 10 sends the series of infrared-light first command signals a, b, c, d corresponding to the first protocol. In a period of time during next two frames (frames 3 and 4), the emitter apparatus 10 sends the series of infrared-light second command signals A, B, C, D corresponding to the second protocol. After that, the emitter apparatus 10 repeatedly and alternately switches the series of first command signals a, b, c, d and the series of second command signals A, B, C, D in a cycle of two frames, and sends the command signals.

Meanwhile, in each of the first glasses 30-1 and the second glasses 30-2, the infrared light receiving section 31 selectively receives the infrared-light command signals 50 through the wavelength filter, and the signal detecting section 32 only receives signals of the receiving-target sub-carrier frequency through the bandpass filter. Further, the command processing section 33 determines only signals having a waveform pattern coincide with one of the reference waveform patterns of commands stored in the memory as significant command signals.

Therefore, the first glasses 30-1 receive the series of first command signals a, b, c, d sent from the emitter apparatus 10 in periods of time during the frames 1 and 2 and the frames 5 and 6, and perform the shutter open/close control based on the command signals. After that, in periods of time during the frames 3 and 4 and the frames 7 and 8 in which the emitter apparatus 10 sends the series of second command signals A, B, C, D, the first glasses 30-1 in the self-propellable state continue the shutter open/close control. Meanwhile, the second glasses 30-2 receive the series of second command signals A, B, C, D sent from the emitter apparatus 10 in periods of time during the frames 3 and 4 and the frames 7 and 8, and perform the shutter open/close control based on the command signals. After that, in periods of time during the frames 1 and 2 and the frames 5 and 6 in which the emitter apparatus 10 sends the series of first command signals a, b, c, d, the second glasses 30-2 in the self-propellable state continue the shutter open/close control.

As described above, according to this embodiment, the one emitter apparatus 10 may perform the shutter open/close controls of the two pairs of glasses 30-1, 30-2 having different protocols. Further, a plurality of users may view 3D images displayed on the one 3D image display apparatus by using the two pairs of glasses 30-1, 30-2 having different protocols. As a matter of course, according to the similar principle, one emitter apparatus may perform shutter open/close controls of three or more pairs of glasses.

### Second Embodiment

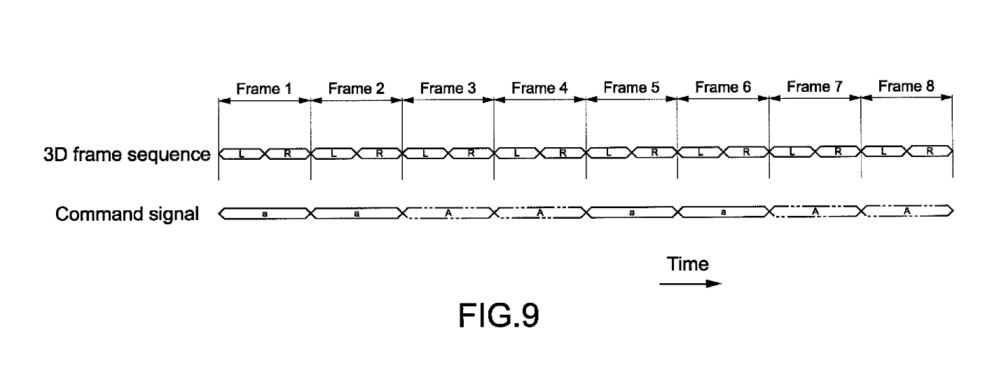

In the first embodiment, as shown in FIG. 9, the series of first command signals corresponding to the first protocol and the series of second command signals corresponding to the second protocol are alternately allocated to all the frame periods every N frames. Note that the series of first command signals a, b, c, d corresponding to the first protocol of FIG. 8 are simply represented by “a” in FIG. 9, and the series of second command signals A, B, C, D corresponding to the second protocol of FIG. 8 are simply represented by “A” in FIG. 9.

Not allocating the command signals of the respective protocols so as to fill in all the frame periods as shown in FIG. 9, the command signals of the respective protocols may be allocated so as to sandwich M number of blank frames, respectively. Here, the blank frame is a frame to which no command signal of the respective protocol is allocated. The number M of blank frames is defined within the range that the intermittent times of the command signals of the respective protocols do not exceed the self-propellable times, respectively.

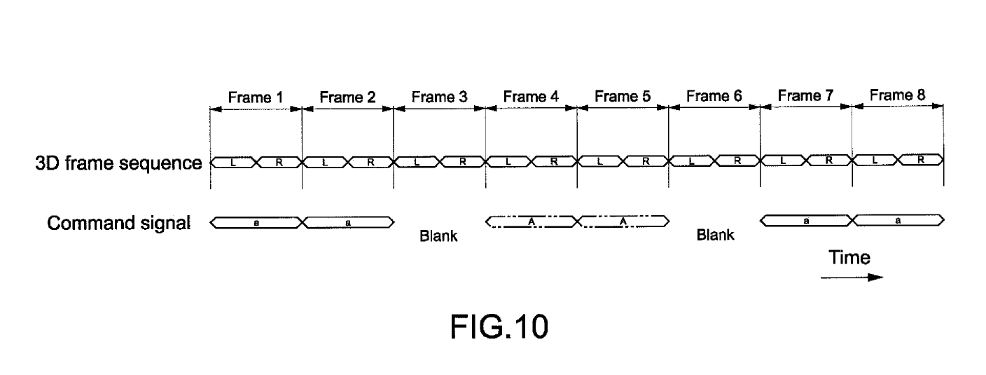

FIG. 10 is a timing diagram relating to shutter open/close controls of the two pairs of glasses 30-1, 30-2 according to a second embodiment employing the above-mentioned blank frames. Here, N=2 and M=1. In this example, the frame 3 and the frame 6 are blank frames. In this case, the period in which the series of command signals corresponding to each protocol are absent is 4 frames. Assuming that one frame is 1/60 seconds, the absent period is 1/15 seconds. Since each of the self-propellable time of the first glasses 30-1 (first self-propellable time) and the self-propellable time of the second glasses 30-2 (second self-propellable time) are about 3 seconds or 4 seconds, the number M of blank frames may be further larger.

### Third Embodiment

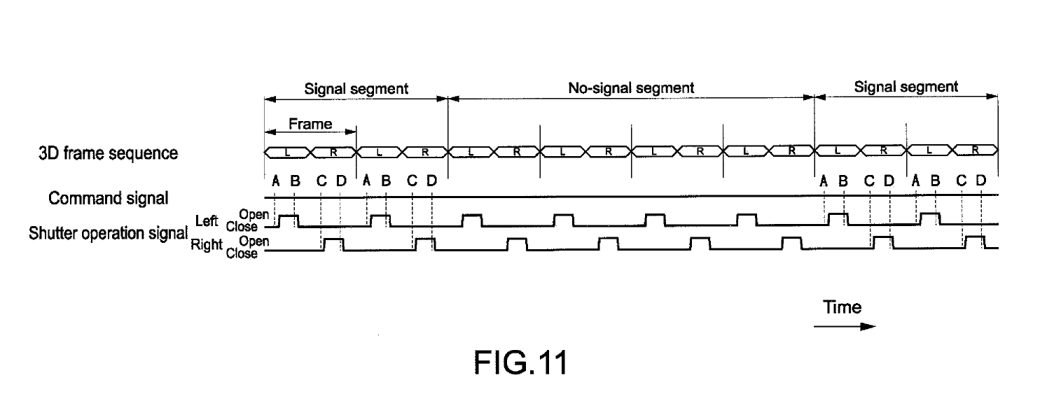

In the above description, both the first glasses 30-1 and the second glasses 30-2 complete the shutter open/close controls based on the series of command signals in each one frame. However, there is a case where, as shown in FIG. 11 for example, the waveforms of the four kinds of command signals are defined as described above, and a chain of signals including a no-signal segment of the predetermined number of frames and signal segments of the predetermined number of frames before and after the no-signal segment are used as a trigger for starting the shutter open/close control by the glasses, which are defined in a protocol. The signal segment includes, for example, the series of command signals of the first protocol or the second protocol described in the first embodiment, and the like. Only after detecting the above-mentioned chain of signals, the glasses start the shutter open/close control, and after that, perform the shutter open/close control based on the command signals in the respective signal segments.

Next, shutter open/close control operations by the two pairs of glasses 30-1, 30-2 in a case where one of the first protocol and the second protocol is determined to cause the glasses to start the shutter open/close control based on the above-mentioned chain of signals will be described. Note that, in this embodiment, it is assumed that the second protocol is determined to do so.

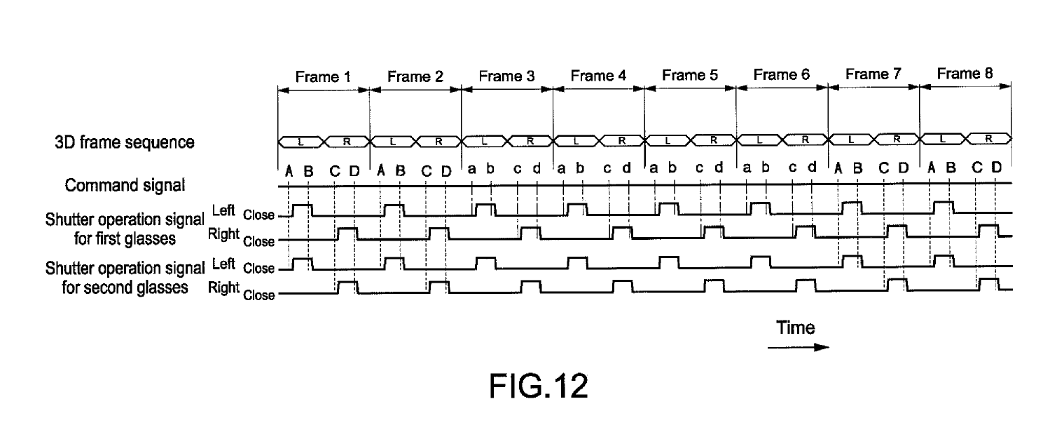

FIG. 12 is a timing diagram relating to shutter open/close controls of the two pairs of glasses 30-1, 30-2 of this embodiment. Beginning at the top, timings of a 3D image frame sequence, infrared-light command signals, left-eye shutter operation signals of the first glasses 30-1, right-eye shutter operation signals of the first glasses 30-1, left-eye shutter operation signals of the second glasses 30-2, and right-eye shutter operation signals of the second glasses 30-2 are shown. Further, a, b, c, and d show sending timings of the series of first command signals L-open, L-close, R-open, and R-close corresponding to the first protocol, respectively. A, B, C, and D show sending timings of the series of second command signals corresponding to the second protocol, respectively. Further, in FIG. 12, the frames 1 and 2 are in a period corresponding to the former signal segment, the frames 3 to 6 are in a period corresponding to the no-signal segment, and the frames 7 and 8 are in a period corresponding to the latter signal segment in the chain of signals.

The controller section 15 of the emitter apparatus 10 controls the switch section 14 to select the second command signals during periods corresponding to the signal segments in the above-mentioned chain of signals, and to select the first command signals during a period corresponding to the no-signal segment. As a result, the emitter apparatus 10 sends the second command signals A, B, C, D during the periods of the frames 1 and 2 and the frames 7 and 8 corresponding to the signal segments, and sends the first command signals a, b, c, d during the period of the frames 3 to 6 corresponding to the no-signal segment.

According to this embodiment also, the command signals of the respective protocols are sent within the range that the intermittent times of the command signals of the respective protocols do not exceed the self-propellable times, respectively. Therefore, the one emitter apparatus 10 may perform the shutter open/close controls of the two pairs of glasses 30-1, 30-2 having different protocols. Further, each pair of glasses 30-1, 30-2 in the self-propellable state surely continue the shutter open/close operation.

### Fourth Embodiment

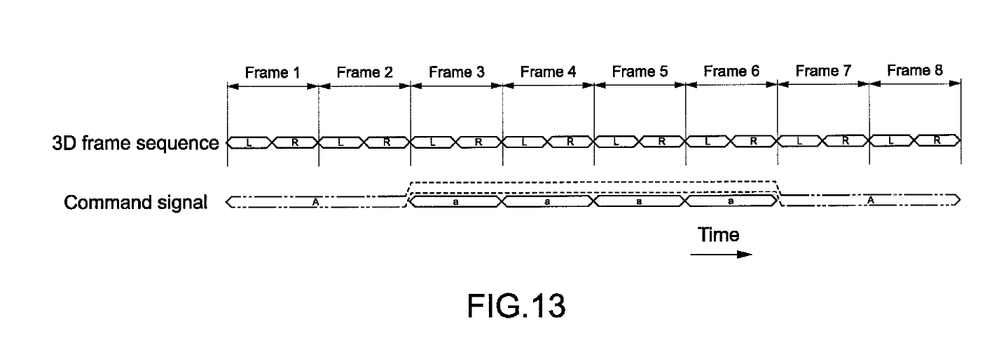

In the third embodiment, as shown in FIG. 13, the series of first command signals corresponding to the first protocol and the series of second command signals corresponding to the second protocol are alternately allocated to all the frame periods every N frames. Note that the series of first command signals a, b, c, d corresponding to the first protocol of FIG. 12 are simply represented by “a” in FIG. 13, and the series of second command signals A, B, C, D corresponding to the second protocol of FIG. 12 are simply represented by “A” in FIG. 13.

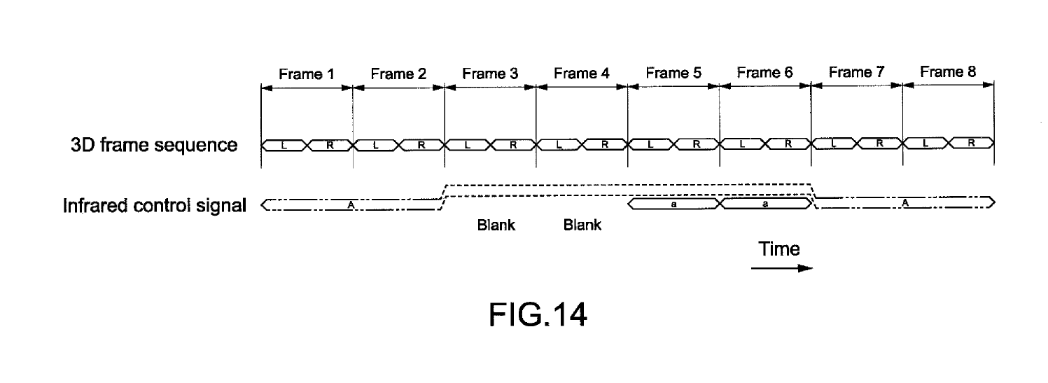

Not allocating the command signals of the respective protocols so as to fill in all the frame periods as shown in FIG. 13, as shown in FIG. 14 for example, part of the frames in the no-signal segment in the above-mentioned chain of signals may be blank frames. Here, the maximum value of the number M of the blank frames that may be provided in the no-signal segment is obtained by subtracting the minimum number of the frames (for example, 2) necessary for calculating the shutter open/close cycle of the glasses 30 from the number of the frames in the no-signal segment.

### Modified Example 1

Next, modified examples of the emitter apparatus will be described.

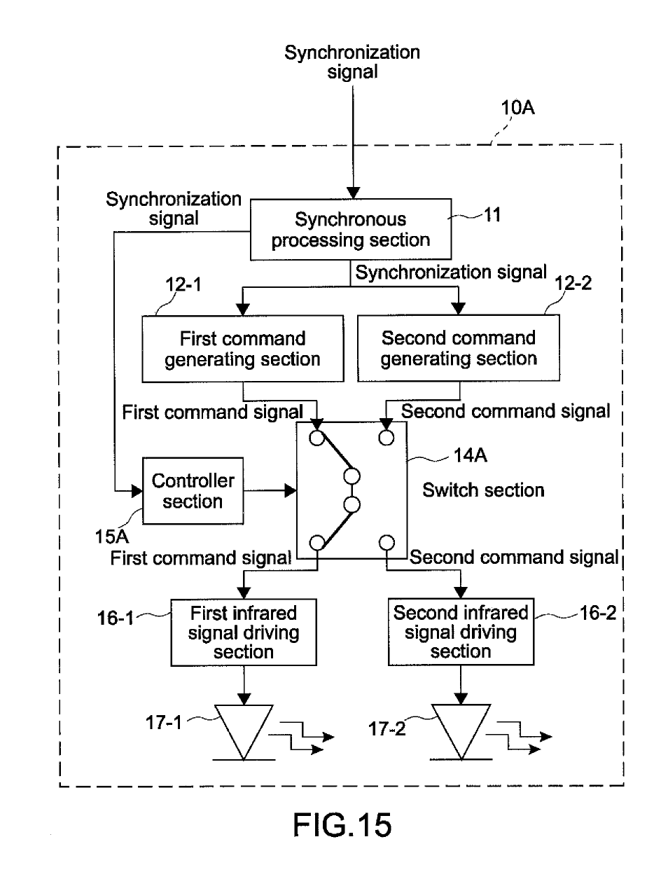

FIG. 15 is a block diagram showing the structure of an emitter apparatus 10A according to a modified example 1.

In a case where the wavelength of infrared light signals that the first glasses 30-1 may receive is different from the wavelength of infrared light signals that the second glasses 30-2 may receive, two infrared light sources 17-1, 17-2 that may emit infrared lights of those wavelengths, respectively, and infrared signal driving sections 16-1, 16-2 driving the infrared light sources 17-1, 17-2, respectively, are provided. Here, an infrared light source of a wavelength corresponding to the first glasses 30-1 is referred to as “first infrared light source 17-1”, and an infrared signal driving section that drives the first infrared light source 17-1 is referred to as “first infrared signal driving section 16-1”. Further, an infrared light source of a wavelength corresponding to the second glasses 30-2 is referred to as “second infrared light source 17-2”, and an infrared signal driving section that drives the second infrared light source 17-2 is referred to as “second infrared signal driving section 16-2”.

A controller section 15A controls a switch section 14A to switch the series of first command signals corresponding to the first protocol and the series of second command signals corresponding to the second protocol to select one of them. At the same time, the controller section 15A switches the first infrared signal driving section 16-1 and the second infrared signal driving section 16-2 as an output target of the command signal selected by the switch section 14A. Specifically, the controller section 15A controls the switch section 14A to output, in a case where the switch section 14A selects the first command signals, the first command signals to the first infrared signal driving section 16-1, and to output, in a case where the switch section 14A selects the second command signals, the second command signals to the second infrared signal driving section 16-2.

According to the modified example 1, even in a case where the wavelength of infrared light signals that the first glasses 30-1 may receive is different from the wavelength of infrared light signals that the second glasses 30-2 may receive, the emitter apparatus 10A may transmit the infrared-light command signals for the shutter open/close control to the respective glasses 30-1 and glasses 30-2.

### Modified Example 2

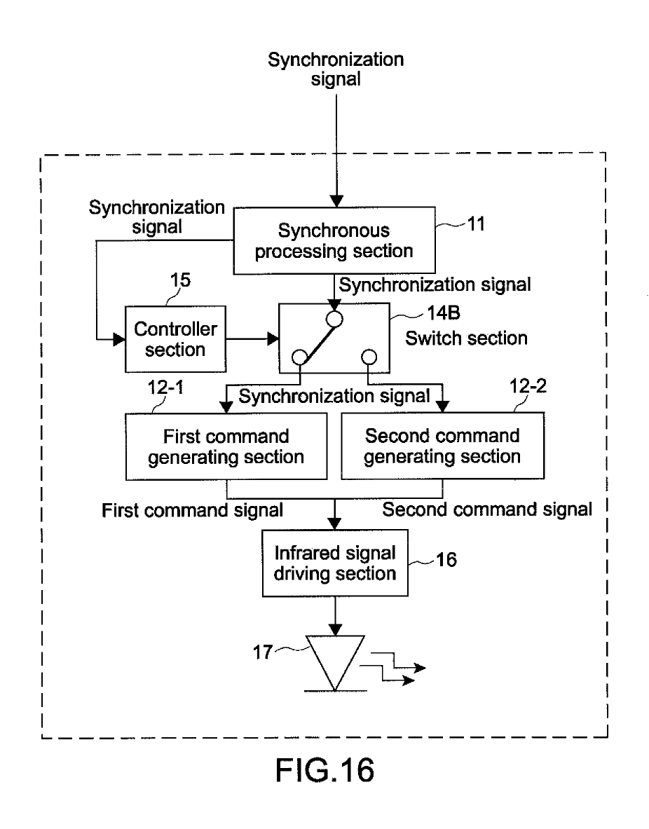

FIG. 16 is a block diagram showing the structure of an emitter apparatus 10B according to a modified example 2.

In the emitter apparatus 10B, a switch section 14B is provided between the synchronous processing section 11 and the respective command generating sections 12-1, 12-2. The switch section 14B switches the first command generating section 12-1 and the second command generating section 12-2 as an output target of the synchronization signal such that the synchronization signal from the synchronous processing section is supplied only to a command generating section that generates command signals to be output. Since this structure may operate only the command generating section that generates command signals to be output, the throughput of the emitter apparatus 10B may be decreased.

### Modified Example 3

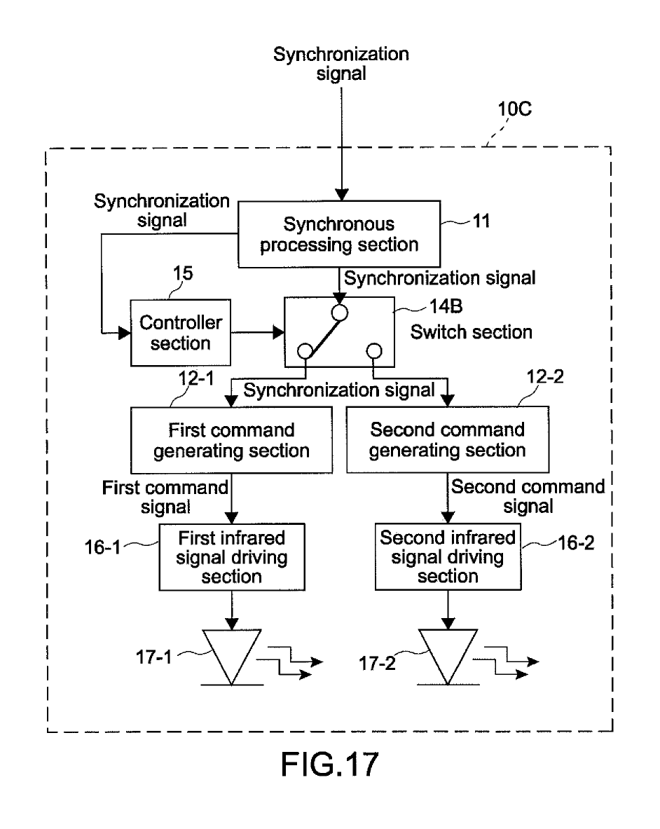

FIG. 17 is a block diagram showing the structure of an emitter apparatus 10C according to a modified example 3.

The emitter apparatus 10C is a combination of the modified example 1 and the modified example 2.

That is, the emitter apparatus 10C includes the first infrared light source 17-1 of the wavelength corresponding to the first glasses 30-1, the first infrared signal driving section 16-1 driving the first infrared light source 17-1, the second infrared light source 17-2 of the wavelength corresponding to the second glasses 30-2, and the second infrared signal driving section 16-2 driving the second infrared light source 17-2. In addition, the switch section 14B is provided between the synchronous processing section 11 and the respective command generating sections 12-1, 12-2. This structure is adaptable to a case where the specs of the wavelength of the infrared light signal for the first glasses 30-1 are different from the specs of the wavelength of the infrared light signal for the second glasses 30-2. In addition, since this structure may operate only the command generating section that generates command signals to be output, the throughput of the emitter apparatus 10C may be decreased.

### Modified Example 4

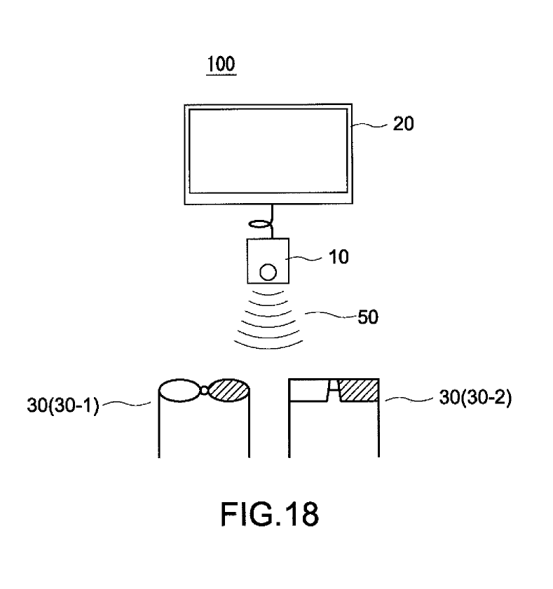

The emitter apparatus 10 may not be embedded in the 3D image display apparatus 20. As shown in FIG. 18, an emitter apparatus 10D detachably and externally provided on the 3D image display apparatus 20 may be provided.

### Other Modified Example

In the above-mentioned embodiments, infrared lights are used as communication media of the command signals.

Alternatively, electromagnetic waves may be adaptable to the present disclosure.

Further, the present disclosure is not limited to the examples shown in the drawings, but may be variously modified within the scope of technological thought of the present disclosure.

The present disclosure contains subject matter related to that disclosed in Japanese Priority Patent Application JP 2010-186985 filed in the Japan Patent Office on Aug. 24, 2010, the entire content of which is hereby incorporated by reference.

It should be understood by those skilled in the art that various modifications, combinations, sub-combinations and alterations may occur depending on design requirements and other factors insofar as they are within the scope of the appended claims or the equivalents thereof.

What is claimed is:

1. An emitter apparatus, comprising:
a plurality of generating sections capable of generating command signals of a plurality of protocols, respectively, the plurality of protocols corresponding to a plurality of pairs of active shutter glasses having different protocols for controlling right-and-left shutters, respectively; and
a command sending section configured to time-division multiplex the command signals of the plurality of protocols generated in the plurality of generating sections, and to send the command signals.

2. The emitter apparatus according to claim 1, wherein
the plurality of pairs of active shutter glasses are capable of continuing operations of alternately opening and closing the right-and-left shutters for predetermined self-propellable times after the command signals stop, respectively, and
the command sending section is configured to time-division multiplex the command signals of the respective protocols such that an intermittent time of each of the command signals of the protocols fails to exceed the self-propellable time, and to send the command signals.

3. The emitter apparatus according to claim 2, wherein
the command sending section is configured to time-division multiplex the command signals of the respective protocols in time units corresponding to a predetermined number of frames, respectively, and to send the command signals.

4. The emitter apparatus according to claim 3, wherein
the predetermined number of frames is the minimum number of frames that each pair of the active shutter glasses are capable of calculating an open/close cycle of the right-and-left shutters.

5. The emitter apparatus according to claim 2, wherein
the command sending section is configured to switch the command signals of the respective protocols such that the respective command signals sandwich at least one blank frame, and to send the command signals.

6. The emitter apparatus according to claim 1, wherein
at least one protocol defines that a chain of signals including a no-signal segment of a first predetermined number of frames and signal segments of a second predetermined number of frames before and after the no-signal segment are used as a trigger for starting a control by the corresponding active shutter glasses, and
the command sending section is configured to send, in at least part of a period corresponding to the no-signal segment, a command signal corresponding to at least one other protocol.

7. The emitter apparatus according to claim 1, wherein
the command sending section includes a plurality of infrared light sources capable of emitting infrared light signals having wavelengths corresponding to the plurality of protocols, respectively.

8. A 3D image display apparatus, comprising:
the emitter apparatus according to claim 1.

9. A command sending method by an emitter apparatus, comprising:
generating command signals of a plurality of protocols, respectively, the plurality of protocols corresponding to a plurality of pairs of active shutter glasses having different protocols for controlling right-and-left shutters, respectively; and
time-division multiplexing the respective generated command signals of the plurality of protocols, and sending the command signals.
